(19) United States
(12) Patent Application Publication
(10) Pub. No.: US 2014/0118267 A1
(43) Pub. Date: May 1, 2014

(54) Code Entry System

(71) Applicant: Vishal Thomas, Bangalore (IN)

(72) Inventor: Vishal Thomas, Bangalore (IN)

(21) Appl. No.: 13/664,657

(22) Filed: Oct. 31, 2012

(51) Int. Cl. G06F 3/041

(52) U.S. Cl. 345/173

(57) ABSTRACT

One or more targets on a touch screen may be provided. The amount of time that the user hovers over a given target may also be an entry. For example, each target may have a preprogrammed time duration. One target may require that the user spend a duration X hovering over the target; another target may require that the user spend duration 2X, and another target may still have another duration. Only if the user touches the right targets in the right order and for the right duration is the code properly entered in some embodiments.

### BACKGROUND

This relates generally to processor-based devices and particularly in some embodiments to devices that have touch screens.

Many mobile devices including cellular telephones commonly have touch screens. Users enter all kinds of data through the touch screen without any other significant user input/output device.

For example, users commonly input a password in order to access their processor-based device. This may be done in a touch screen system which automatically displays a user interface with a series of text entry locations, such as four blanks, to be filled in by the user. The user then uses a touch screen keyboard to enter a code. If the correct code is entered, access is permitted.

Some processor-based devices, including cellular telephones, also display a pattern or array of touch targets that can be touched by the user. If the user touches some portion of those targets in a predetermined sequence, this constitutes a text entry of a code that may also allow access to the device or to some software program or database.

One issue with such text code entry protocols is that they may be susceptible to being stolen in one of at least two ways. Because the number of opportunities or options are somewhat limited, an interloper may be able to define the pattern. Also because it is a geometric pattern, someone observing the user entering the pattern may be able to duplicate it simply by seeing the pattern of user's hand movement over the touch screen.

### BRIEF DESCRIPTION OF THE DRAWINGS

Some embodiments are described with respect to the following figures:

FIG. 1 is a depiction of a user interface on a screen in accordance with one embodiment;

FIG. 2 is a flowchart for one embodiment of method for code entry; and

FIG. 3 is a system depiction for one embodiment.

### DETAILED DESCRIPTION

In accordance with some embodiments, the entry of codes into touch screen displays may be facilitated and security may be improved. Particularly, an additional dimension of data entry, that may not be visible to surrounding persons, may be added to the data entry or code entry protocol. Particularly, in addition to a pattern of data entry, in some embodiments, the time that the user spends hovering over a target may be an indication of a code as well.

One or more targets on a touch screen may be provided. The amount of time that the user hovers over a given target may also be an entry. For example, each target may have a preprogrammed time duration. One target may require that the user spend a duration X hovering over the target; another target may require that the user spend duration 2X, and another target may still have another duration. Only if the user touches the right targets in the right order and for the right duration is the code properly entered in some embodiments.

Moreover, the system may provide hints for the user for each time duration. The hints may be visual, for example by changing colors of the targets or some other location on the display, they may be tactile such as providing vibratory feedback at each time interval or they may be audible. These hints operate as feedback to the user to remove the user's finger from the target at the right time to provide a time input.

As a result, one merely watching the text entry may not be able to define the code because there is no visible movement in the user's hand associated with the time entries. Particularly with vibratory time feedback to the user, it may be very difficult for an interloper to define the code merely by watching the user. In addition, the number of variations of text entry to enter the code, with additional time data, may be so high that random attacks may be practically foreclosed.

Thus in some embodiments, the entry of a code may be facilitated. The code may be, for example, a password to gain entry to the device. Another code may be a code in order to access software. Still another code may be code to access a database. An additional code may be, in some embodiments, code to access a network. Still other embodiments of codes include codes to access a bank account, codes to access a camera feed, or codes to access media such as video or other streaming media.

Embodiments may be applicable to any kind of touch screen device including a cellular telephone, a laptop computer, a tablet, a mobile Internet device, or any other device with a touch screen.

While embodiments are disclosed in which feedback is provided to the user for the timing, the timing may also be defined from a simple clock mechanism that shows time. In some embodiments no specific time feedback may be provided.

While embodiments are described in which a pattern of touch targets must be traversed in order, in other embodiments no such pattern may be required or only a single target may be provided. Relatively complex code inputs can be entered from a single target by requiring a pattern of touching and removing of the user's finger. For example, the pattern could be hold the finger on the target for three seconds, release, hold on target for 2 seconds, release; hold on target for four seconds, release; hold on target for 1 second and then release. Thus the use of number of targets and the requirement for traversing a pattern of targets may be optional in some embodiments.

Some embodiments may be advantageous because they do not require any additional hardware. Even vibratory feedback is available on most cellular telephones. Timers for timing touch entries generally may be available on most touch screen devices. Thus in some embodiments the improvements described herein may be implemented solely on software, reducing the cost of adopting the techniques described herein in some cases.

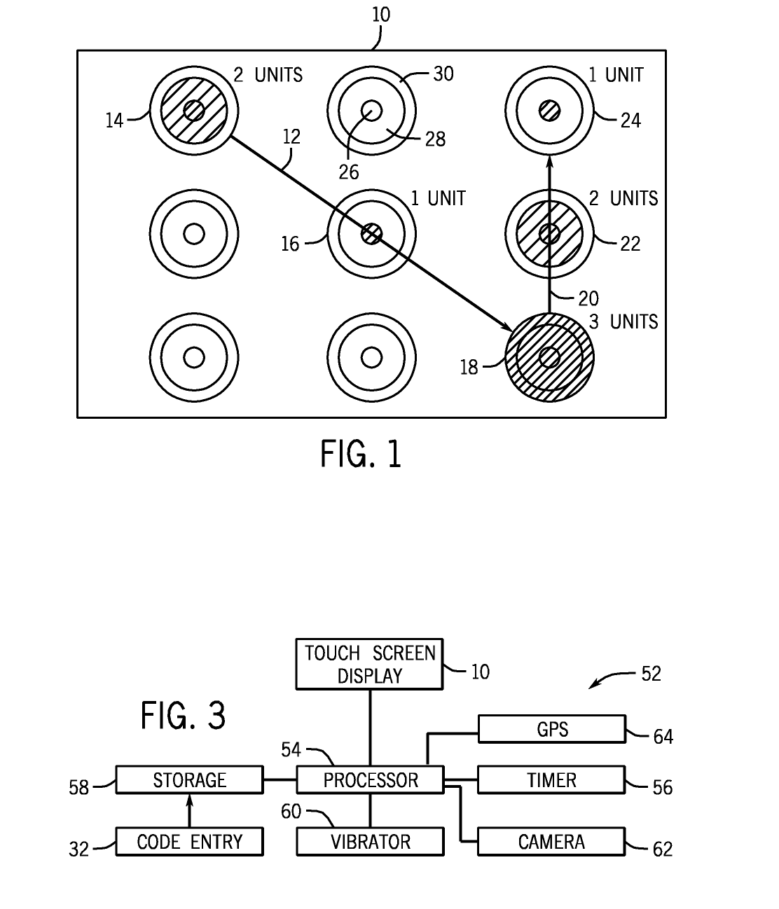

Referring to FIG. 1, an example of a touch screen 10 graphical user interface is displayed. In this case, there are an array of nine touch targets indicated as circles arranged in a 3×3 matrix. More or less targets may be used. For example a 2×2 matrix may be used, and 1×1 matrix may be used or larger matrixes may be used depending on the magnitude of the security concerns.

In one embodiment, each target consists of three concentric circles. The inner circle 26 may be one color in one embodiment, the intermediate circle 28 may be another color in one embodiment and the outer circle 30 may be still another color in one embodiment. The colors may provide feedback on the elapsed time of touching. For example, as indicated by the target 18, when the user has hovered over the target for three seconds, all three concentric areas become the same color. Conversely when the user hovers over the target 16 for only one unit of time, only the center circle changes color. As still another example when the target 14 is hovered over for two units of time both the inner and intermediate circles may change color.

In other embodiments, vibratory feedback may be provided. For example at a first time interval, one vibration may be provided and the next time interval, two vibrations may be provided and the next interval, three vibrations may be provided.

Thus through the use of visual, audible or tactile feedback, the user can determine whether the user has maintained contact with the target for the encoded amount of time. Then the user can simply can release the user's finger from the target at the right and, in multiple target code entry embodiments, move on to the next target.

Thus in the example depicted in FIG. 1, the pattern of movement from target to target is indicated by the arrows 12 and 20. If the user touches each target along the path 12 and 20 for the desired duration, correct code entry is confirmed. In this case, the user must hover over the target 14 for two units of time, the target 16 for one unit of time, the target 18 for three units of time, the target 22 for two units of time, and the target 24 for one unit of time in the indicated sequence. Of course other sequences and time durations are contemplated.

In some embodiments, in addition or as an alternative to visual or vibratory feedback, audible feedback may be provided. The audible feedback may be in terms of a computer produced sound such as a beep. The beep may include one or more successive beeps to indicate the time intervals during which the finger has been maintained over the target. In addition, the feedback may be visual but unconnected to the particular target and may be displayed on another area of the screen. For example, a timer may be displayed or a simple display that indicates one unit, two units, three units to indicate to the user when to remove the user's finger.

In other embodiments instead of arrays of targets, a simple visual display may be provided that appears to be nothing more than a scene. Then an interloper may have no idea that it is a code entry graphical user interface. Only when the user touches objects in the scene for a desired duration, is the code detected. For example the scene may have horses, cows, chickens and pigs depicted. In order to correctly enter the code, the user may have to contact the objects in a particular sequence in one embodiment. In addition each object must be touched for the predetermined or pre-stored time. In other embodiments no particular sequence of touching is required but only that each of the required items be touched for the preprogrammed amount of time.

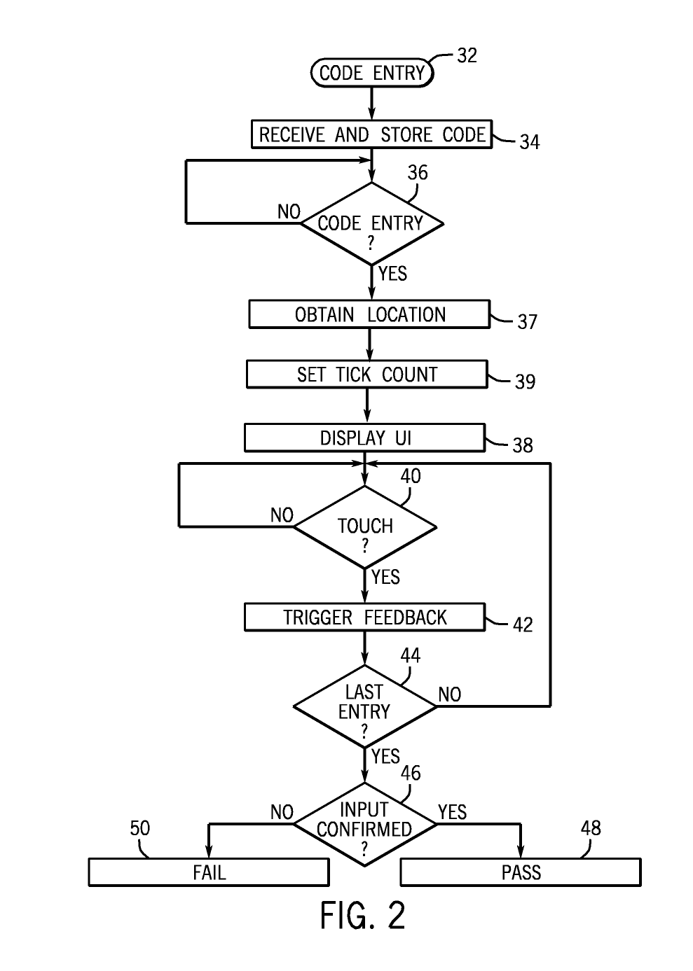

Referring to FIG. 2, in accordance with some embodiments, the sequence of code entry 32 may be implemented in software, firmware and/or hardware. In software and firmware embodiments it may be implemented by computer executed instructions stored in one or more non-transitory computer readable media such as magnetic, optical, and/or semiconductor storages.

In one embodiment, the code entry sequence 32 begins by receiving and storing a predetermined code as indicated in block 34. In some embodiments the code may be entered by the manufacturer or software provider as a default code. In some embodiments, the user can preprogram the code as desired. For example, the user, in a code entry setup phase, may simply touch a pattern of targets for a desired sequence and a desired duration that is then stored as the required code.

Next at diamond 36 an indication is provided at whether the user wishes to enter code. For example the code may be entered automatically each time the computer is turned on, based on some prompt in a software program, or upon user request via user input to mention a few examples. If code entry is precipitated as determined in diamond 36, the appropriate graphical user interface, such as the one shown in FIG. 1, may be displayed as indicated in block 38.

The way that the user interface for code entry is implemented may be varied depending on user's current location in some embodiments. That location may be automatically determined by an onboard positioning system such as a global positioning system (GPS). Thus given the location of the user's processor-based device, one may wish to increase or decrease the level of security that is offered. For example, instead of using the visual identification of time ticks, a vibratory indication may be provided in some cases when security concerns are high. Security concerns may be high at public places with lots of people, like airports. Places may be identified as airports or other places of concern based on databases that correlate GPS positions to the type of facility at that location. Then this information about the type of facility or location may be used to access a security risk, using a table that correlates given types of locations with given security levels.

Thus the amount of time for entry of data may be changed in some cases. As one example, the time correlated with the number of units may be changed. For example, when low security is involved, one tick may be half a second and when high security is involved, one tick may involve three seconds and may be indicated by vibration rather than a visual indication. Other variations may occur as well based on location. In another embodiment, rate of time is different for each touch location (you can see it flash faster or slower, or vibrate at different frequency).

In some cases, the type of location or facility may be determined from metadata associated with a global positioning system horizontal and vertical coordinates using a service offered by particular websites. In some cases the time associated with a tick may also be changed by the user based on the user's current security preferences.

Thus referring to FIG. 2, after a code entry is detected, the user's location may be obtained as indicated in block 37. Based on the location, metadata associated with that location in a table that correlates locations to security concerns may be obtained. Then a tick count time may be set as indicated in block 39 and the type of indication be it visual, vibratory or audible may be adjusted based on the level of security concerns given a known location.

Then the system waits for a touch entry which is detected at diamond 40. When a touch entry is detected, in some embodiments feedback may be triggered as indicated in block 42. Again the feedback may be tactile, visual, or audible. The visual feedback may be in terms of colors, time duration flashes, text or any other visual cue. When the last entry has been detected at diamond 44, a check at diamond 46 determines whether the user has input the correct code. If so, a pass indication may be provided as indicated at block 48 and otherwise a fail indication is provided at 50. If it is not the last entry, the system continues to monitor for touches and their duration until the last entry is reached.

In some embodiments, the user may be provided an opportunity to retry if an incorrect entry is provided. For example if a given number of incorrect entries are provided, the system may take other action such as locking down the computer and refusing to allow any further input, allowing entry to only a non-secure mode, sending an email to notify someone of repeated incorrect entries, disabling storage devices to prevent interlopers from gaining access to secure information, automatically making a telephone call to the user to indicate to the user that a suspicious code entry has been detected or any other action that may be desired.

Still another option in connection with improper entry may be to automatically take a picture of the person making the entries. If the picture matches a pre-stored image of the user, additional opportunities for code entry may be provided and if not, further entries may be truncated or precluded. In some embodiments, visual identification may be used to provide a margin of error in text entries. For example if one or more timed entries are not provided in exactly the right information but other confirmation is received such as a visual identification of the user, the entries may be nonetheless accepted in some cases. Also visual identification may lead to offering a quicker or simpler code entry protocol.

In other embodiments, the same techniques may be used in connection in connection with conventional non-touch screen input devices by simply using a camera to image the user working through a virtual screen. Specifically, the user's pattern of finger movement and their timed duration may be indicative of the right code entry. When this information is captured by a video camera and the video analytics are used to analyze that pattern, the correct code entry can be confirmed. Feedback may be provided on a conventional non-touch screen in some embodiments.

Thus referring to FIG. 3, one embodiment of a system 52 in the form of a processor-based device is depicted. Other embodiments including ones without touch screen displays, vibrators or cameras may also be contemplated. The touch screen display 10 may be coupled to a processor 54. The processor 54 may be in turn coupled to a timer function 56 which may be a discrete timer or may be implemented in software stored in the processor 54 or separate storage 58 coupled to the processor 54. The storage 58 may store code entry software 32 in accordance with one embodiment. A vibrator 60 may be coupled to the processor and may be controlled by the processor to provide feedback to the user to help the user in defining the desired time intervals. In some embodiments, camera 62 may be coupled to the processor to provide visual information such as to provide a video feed of the users pattern of touch entries. In some embodiments, a projector may be provided to display a pattern of targets for the user to touch and a camera may record the duration of the touches and the pattern of touches.

In addition, a global positioning system, sensor 65 may be provided in order to give position information. Thus, a GPS sensor 64 may be coupled to the processor 54 in some embodiments. The global positioning system sensor may correlate with software that enables the type of location, such as airport, restaurant, etc. to be determined. Then a table or database may be provided in the storage 58 to correlate the type of location with a level of security and further to correlate that information with an adjustment of either the time per tick or the way that ticks are identified be it visual, auditory or tactile.

Thus as used herein, a touch screen may be any display surface that the user touches in order to enter code including a conventional touch sensitive screen and a projected pattern on any surface to trigger the user to enter a given code entry.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

Additional Notes and Examples:

One example embodiment may be one or more computer readable storage media storing instructions executed by a computer to determine a touch entry duration, comparing said entry duration to a stored duration; and if said entry duration corresponds to said stored duration, indicate that a code has been entered correctly. The media may store instructions to provide feedback to indicate a time duration. The media may store instructions to provide feedback in visual form. The media may store instructions to provide feedback in tactile form. The media may store instructions to provide feedback in the form of a vibration. The media may store instructions to provide feedback to indicate the amount of a time duration to aid the user in determining how much time to touch a touch screen keyboard to make a key entry. The media may store instructions to provide an output indicative of a series of time intervals. The media may store instructions to determine the position of said computer and to use said position to vary said stored time duration. The media may store instructions to use said position to change the way that the user receives feedback about a touch entry. The media may store instructions to increase an amount of touch entry time that signifies a code based on a determination of the location of said computer.

Another example embodiment may be a method comprising receiving a touch entry in a processor-based device, determining in said processor-based device a time duration of the touch entry, determining in that device whether the touch entry time duration corresponds to a stored time duration indicative of a code, and if so, indicating that the code has been entered correctly. The method may also include providing an output indicative of a series of time intervals. The method may also include providing an output includes providing a visual indication of a time interval. The method may also include providing an output indicative of a series of time intervals includes providing a tactile input indicative of a time interval. The method may also include providing an output indicative of a series of time intervals includes providing an audible output. The method may also include receiving said entry on a touch screen. The method may also include detecting the position of the processor-based device and using said position to adjust a entry time duration. The method may also include using said position to change the way that the user receives feedback about a touch entry.

Another embodiment may be an apparatus comprising a touch screen display, and a processor coupled to said display to compare a plurality of touch entry times to stored values to determine if a code has been correctly entered. The apparatus may include said processor to generate an output indicative of a series of consecutive time intervals. The apparatus may include said output appears on said display. The apparatus may include said output is a tactile output. The apparatus may include said processor to use a position of said apparatus to make a comparison to a plurality of touch entry times. The apparatus may include said processor to provide an indication of time to a user. The apparatus may include said processor to charge said indication based on a position of said apparatus. The apparatus may include a timer. The apparatus may include a timer set for variable rate of time for each hover location to provide tick feedback to indicate that time is running at a different rate. The apparatus may include a camera, a global positioning sensor and a vibrator.

What is claimed is:

1. One or more computer readable storage media storing instructions executed by a computer to:
determine a touch entry duration;
comparing said entry duration to a stored duration; and
if said entry duration corresponds to said stored duration, indicate that a code has been entered correctly.

2. The media of claim 1 further storing instructions to provide feedback to indicate a time duration.

3. The media of claim 2 further storing instructions to provide feedback in visual form.

4. The media of claim 2 further storing instructions to provide feedback in tactile form.

5. The media of claim 4 further storing instructions to provide feedback in the form of a vibration.

6. The media of claim 1 further storing instructions to provide feedback to indicate the amount of a time duration to aid the user in determining how much time to touch a touch screen keyboard to make a key entry.

7. The media of claim 1 further storing instructions to provide an output indicative of a series of time intervals.

8. The media of claim 1 further storing instructions to determine the position of said computer and to use said position to vary said stored time duration.

9. The media of claim 8 further storing instructions to use said position to change the way that the user receives feedback about a touch entry.

10. The media of claim 7 further storing instructions to increase an amount of touch entry time that signifies a code based on a determination of the location of said computer.

11. A method comprising:
receiving a touch entry in a processor-based device;
determining in said processor-based device a time duration of the touch entry;
determining in that device whether the touch entry time duration corresponds to a stored time duration indicative of a code; and
if so, indicating that the code has been entered correctly.

12. The method of claim 11 including providing an output indicative of a series of time intervals.

13. The method of claim 12 wherein providing an output includes providing a visual indication of a time interval.

14. The method of claim 12 wherein providing an output indicative of a series of time intervals includes providing a tactile input indicative of a time interval.

15. The method of claim 12 wherein providing an output indicative of a series of time intervals includes providing an audible output.

16. The method of claim 11 including receiving said entry on a touch screen.

17. The method of claim 11 including detecting the position of the processor-based device and using said position to adjust a entry time duration.

18. The method of claim 17 including using said position to change the way that the user receives feedback about a touch entry.

19. An apparatus comprising:
a touch screen display; and
a processor coupled to said display to compare a plurality of touch entry times to stored values to determine if a code has been correctly entered.

20. The apparatus of claim 19, said processor to generate an output indicative of a series of consecutive time intervals.

21. The apparatus of claim 20 wherein said output appears on said display.

22. The apparatus of claim 19 wherein said output is a tactile output.

23. The apparatus of claim 19, said processor to use a position of said apparatus to make a comparison to a plurality of touch entry times.

24. The apparatus of claim 23, said processor to provide an indication of time to a user.

25. The apparatus of claim 24, said processor to charge said indication based on a position of said apparatus.

26. The apparatus of claim 19 including a timer.

27. The apparatus of claim 26 including a timer set for variable rate of time for each hover location to provide tick feedback to indicate that time is running at a different rate.

28. The apparatus of claim 19 including a camera.

29. The apparatus of claim 19 including a global positioning sensor.

30. The apparatus of claim 19 including a vibrator.
